(19) United States
(12) Patent Application Publication
(10) Pub. No.: US 2007/0067838 A1
(43) Pub. Date: Mar. 22, 2007

(54) SYSTEM, MOBILE NODE, NETWORK ENTITY, METHOD, AND COMPUTER PROGRAM PRODUCT FOR NETWORK FIREWALL CONFIGURATION AND CONTROL IN A MOBILE COMMUNICATION SYSTEM

(75) Inventor: Gabor Bajko, Budapest (HU)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/533,218

(22) Filed: Sep. 19, 2006

Related U.S. Application Data
(60) Provisional application No. 60/718,381, filed on Sep. 19, 2005.

(51) Int. Cl. G06F 17/00

(52) U.S. Cl. 726/11

(57) ABSTRACT

A system, mobile node, network entity, method and computer program product for providing firewall protection for a wireless communication network are provided in which a firewall profile is accessed by the network entity when a mobile node connects to the network. The firewall profile defines a list of static firewall pinholes which are opened in a firewall by the network entity. The mobile node may open additional pinholes dynamically. The opened pinholes are closed by the network entity when the mobile node disconnects from the network.

### CROSS REFERENCE TO A RELATED APPLICATION

The present application claims priority to U.S. Provisional Application No. 60/718,381 filed Sep. 19, 2005, the contents of which are incorporated by reference herein in their entirety.

### FIELD OF THE INVENTION

Embodiments of the invention generally relate to wireless networks, and more particularly to the use of firewalls in a wireless communication system.

### BACKGROUND OF THE INVENTION

Wireless communication systems and networks are used in connection with many applications and devices, including for example, portable communication devices (PCDs) (e.g., cellular telephones), portable digital assistants (PDAs), laptop computers, or any suitable device that is capable of communicating with a wireless network. Such devices may be termed mobile devices, mobile terminals (MTs), access terminals (ATs), mobile stations, or mobile nodes (MNs). Examples of wireless communications networks include GSM (Global Systems for Mobile Communication), WCDMA (Wideband Code Division Multiple Access), and CDMA (Code Division Multiple Access). CDMA systems operate by dividing a radio spectrum to be shared by multiple users through the assignment of unique codes. CDMA systems assign a unique code to each signal that is to be transmitted, and are thereby able to spread many simultaneous signals across a wideband spread spectrum bandwidth. Using the respective codes, the signals can then be detected and isolated from the other signals that are being transmitted over the same bandwidth.

Among possible choices for CDMA networks is CDMA2000, also known as IMT-CDMA, that is a code-division multiple access (CDMA) version of the IMT-2000 (International Mobile Telecommunications-2000) standard developed by the International Telecommunication Union (ITU). The CDMA2000 standard is third-generation (3G) mobile telecommunications technology. CDMA2000 can support mobile data communications at speeds ranging from 144 Kbps to 2 Mbps, and in 2000, was the first 3G technology to be commercially deployed as part of the ITU's IMT-2000 framework.

Increasing numbers of mobile devices, such as those communicating over a CDMA2000 network, are capable of data communication using Internet Protocol (IP) communication. Any device communicating via IP, including mobile devices, may require protection from malicious network traffic. As well known, firewalls in network communications systems guard a trusted network from an outside network, such as the Internet. In operation, firewalls act on both the incoming traffic to, and outgoing traffic from, the trusted network. Firewalls determine whether to allow the incoming traffic to pass to a destination within the trusted network, and whether to allow the outgoing traffic to pass to a destination outside the trusted network. Typically, to make the decisions, most firewalls maintain an access control list (ACL) that includes parameters for allowing traffic to pass into and out of the network. Generally, firewalls operate according to a default policy of prohibiting traffic from passing into and out of the trusted network, unless the incoming and outgoing traffic meets the parameters configured in the ACL. In order to allow communication into or out of a trusted network, a pinhole may be established in the firewall.

The use of firewalls (FWs) may also present problems for communication systems. Each system typically has a set of requirements for the FWs, and these requirements determine how the FWs are going to behave. The 3GPP2 system requirements for firewalls are described in Network Firewall Configuration and Control—NFCC, Stage 1 Requirements (3GPP2 S.R0103-0, V1.0, Dec. 9, 2004), the contents of which are incorporated herein in its entirety. For several reasons, the mobile device may have difficulty in performing the firewall functions. The purpose of using FWs in a 3GPP2 system is not only to protect the network, but also to prevent unsolicited traffic to be delivered to the MNs using the very expensive air interface. As such, it may be undesirable to allow all IP traffic to pass to the mobile device without being filtered by a firewall, as many unwanted data packets may be transmitted to the mobile device. Additionally, the load on the authentication, authorization and accounting (AAA) server may be increased due to the need to authenticate unwanted data packets. Data latency may increase due to increases in unwanted data traffic over the wireless network. Performing the firewall functions on the mobile device may consume battery power and thus reduce battery life.

### BRIEF SUMMARY OF THE INVENTION

One exemplary embodiment of the present invention provides an architecture which is able to fulfill the requirements present in the NFCC Stage 1 Requirements. The architecture may be modular with the possibility to be simplified if some of the requirements present in the NFCC Stage 1 Requirements do not need to be supported by a system deploying these FWs.

A system, mobile node, network entity, method and computer program product for providing firewall protection for a wireless communication network are therefore provided in which a firewall profile is accessed by the network entity when a mobile node connects to the network. The firewall profile defines a list containing zero or more static firewall pinholes which are opened in a firewall by the network entity at the time when the MN attaches to the network. The mobile node may open additional pinholes dynamically. The opened pinholes are closed by the network entity when the mobile node disconnects from the network.

In this regard, a system for providing firewall protection for a wireless communication network includes a mobile node, a firewall, and a network entity. The firewall is disposed along a communications path between the mobile node and an outside node, and is capable of filtering the data between the outside node and the mobile node. The network entity is capable of determining a connection of the mobile node to the wireless communication network. The network entity is further capable of accessing a firewall profile associated with the mobile node, the firewall profile comprising zero or more predefined static pinholes. The network entity is further capable of instructing the firewall to open a pinhole corresponding to the at least one predefined static pinhole.

The firewall may be further capable of receiving a dynamic pinhole request from the mobile node and transmitting an authentication request in response to the dynamic pinhole request. The firewall may be further capable of receiving a successful authentication and opening a pinhole corresponding to the dynamic pinhole request in response to the successful authentication of the mobile node. The FW may also be capable to communicate with network entities capable of authenticating the MN and/or authorizing the MN's request.

The firewall is further capable of closing a pinhole in response to a request from the mobile node. In one embodiment, the firewall profile further comprises all network identifiers (e.g., IP addresses) corresponding to the mobile node (i.e., the IP addresses that the MN possesses and is authorized to use). If the firewall receives a request from the mobile node to close the pinhole using a second network identifier different than a first network identifier that was used by the mobile node to request to open the pinhole, the firewall may be further capable of sending an authorization request to the network entity to determine if the first and second network identifiers both belong to the mobile node.

The system may further comprise a plurality of firewalls that are capable of performing a pinhole synchronization, such that any pinhole opening in at least one firewall is opened in all of the firewalls.

In addition to the system for providing firewall protection for a wireless communication network as described above, other aspects of embodiments of the invention are directed to corresponding network entities, mobile nodes, methods, and computer program products for providing firewall protection for a wireless communication network.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of one type of system that would benefit from embodiments of the invention; and

FIGS. 2A, 2B, and 2C are a flowchart illustrating the operation of providing firewall protection for a wireless communication network, in accordance with one embodiment of the invention.

### DETAILED DESCRIPTION OF THE INVENTION

Embodiments of the invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

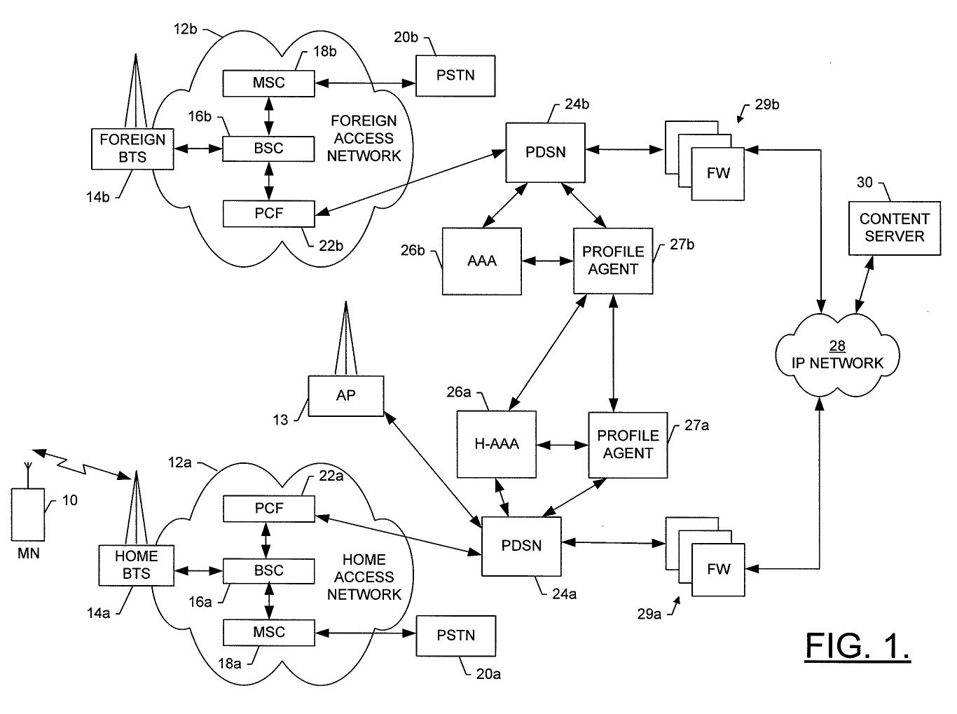

Referring to FIG. 1, an illustration of one type of system that would benefit from embodiments of the invention is provided. The system can include one or more mobile nodes (MN) 10 (also termed terminals, access terminals, mobile terminals, mobile devices, or mobile stations). Each MN will typically have a mechanism for transmitting signals to and for receiving signals from one or more access points (APs), such as an antenna or a wireless local area network (WLAN) card. In one embodiment, the access points may be base transceiver stations (BTS's) 14 (also termed base stations), two of which are shown in FIG. 1 (shown as including a home BTS 14a and a foreign BTS 14b). The BTS is a part of one or more cellular or mobile networks that each includes elements which may be required to operate the network. The user of the MN 10 may be executing a voice or data service such that the MN is communicating with the home access network 12a. If the user is traveling away from the home AN, the MN may need to communicate with an access network operated by a different wireless communication service provider, such as the foreign access network 12b. In an alternative embodiment, the access point may be a wireless access point 13, such as a WLAN access point.

An AP, such as a BTS or a wireless access point, acts as the interface between a network and a mobile node, in that the AP converts digital data into radio signals and converts radio signals into digital data. Each AP generally has an associated radio tower or antenna and communicates with various access terminals using radio links. In particular, APs communicate with various access terminals through the modulation and transmission of sets of forward signals, while APs receive and demodulate sets of reverse signals from various access terminals that are engaged in a wireless network activity (e.g., a telephone call, Web browsing session, etc.).

In one embodiment, BTSs connect to one or more base station controllers (BSCs) 16, two of which are shown in FIG. 1 (shown as including a home BSC 16a and a foreign BSC 16b). The system of this embodiment may also include a mobile switching center 18 (MSC), two of which are shown in FIG. 1 (shown as including a home MSC 18a and a foreign MSC 18b). As known in the art, BSCs are generally responsible for managing the radio resources for one or more BTSs. For example, BSCs may handle radio-channel setup, frequency hopping, and handovers. Moreover, the MSC is responsible for providing the interface between the radio access network 12 (RAN), which includes BTSs 14, BSCs 16, and packet control functions 22 (PCFs) (including a home PCF 22a and a foreign PCF 22b), and a public switched telephone network 20 (PSTN) (including a home PSTN 20a and a foreign PSTN 20b). In particular, MSC 18 controls the signaling required to establish calls, and allocates RF resources to BSCs and PCFs. In operation, the MSC is capable of routing calls, data or the like to and from mobile stations when those mobile stations are making and receiving calls, data or the like. The MSC can also provide a connection to landline trunks when mobile stations are involved in a call.

In one embodiment, such as a CDMA2000 system, PCFs are used to route IP packet data between access terminals (when within range of one of BTSs) and a packet data service node 24 (PDSN) (shown as including a home PDSN 24a and a foreign PDSN 24b). A PDSN, in turn, may be used to provide access to one or more IP networks 28, such as, for example, the Internet, intranets, applications servers, or corporate virtual private networks (VPNs). In this manner, a PDSN acts as an access gateway. In an alternative embodiment, such as a WLAN system, the PDSN may act as an access gateway for a wireless access point 13. The PDSN may communicate with the network 28 through one or more firewalls 29 (shown as including home firewalls 29a and foreign firewalls 29b). A PDSN generally also acts as a client for an Authentication, Authorization, and Accounting (AAA) server 26 (shown as including a home AAA server 26a and a foreign AAA server 26b). As known in the art, an AAA server may be used to authenticate and authorize access terminals before access is granted to an IP network. Once access is authorized, an access terminal may communicate with a content server 30, which may be capable of providing information, data, and/or services to the access terminal. As will be described in more detail below, the PDSN may be in communication with a profile agent 27 (shown as including a home profile agent 27a and a foreign profile agent 27b).

Although not every element of every possible network is shown and described herein, it should be appreciated that the mobile node 10 may be coupled to one or more of any of a number of different networks using one or more of any of a number of different modes (also referred to herein as protocols). In this regard, mobile node(s) can be capable of supporting communication in accordance with any one or more of a number of first-generation (1G), second-generation (2G), 2.5G and/or third-generation (3G) mobile communication protocols or the like. More particularly, one or more mobile stations may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as CDMA2000 and Universal Mobile Telephone System (UMTS) network employing Wideband Code Division Multiple Access (WCDMA) radio access technology. Additionally, one or more network(s) may be capable of supporting wide area network (WAN) communications, such as WLAN (IEEE 802.11) or WiMAX (802.16). Some narrow-band AMPS (NAMPS), as well as TACS, network(s) may also benefit from embodiments of the invention, as should dual or higher mode mobile stations (e.g., digital/analog or TDMA/CDMA/analog phones).

As will be appreciated, a number of the entities of the system of FIG. 1 can be configured in any of a number of different architectures to perform any of a number of functions. For example, the entities of the system of FIG. 1 can be configured in a centralized client-server architecture, decentralized architecture and/or proxy architecture. Additionally or alternatively, for example, the entities of the system of FIG. 1 can be configured in an architecture given in the Scalable Network Application Package (SNAP) (formerly Sega Network Application Package) provided by Nokia Corporation for applications such as in the context of gaming.

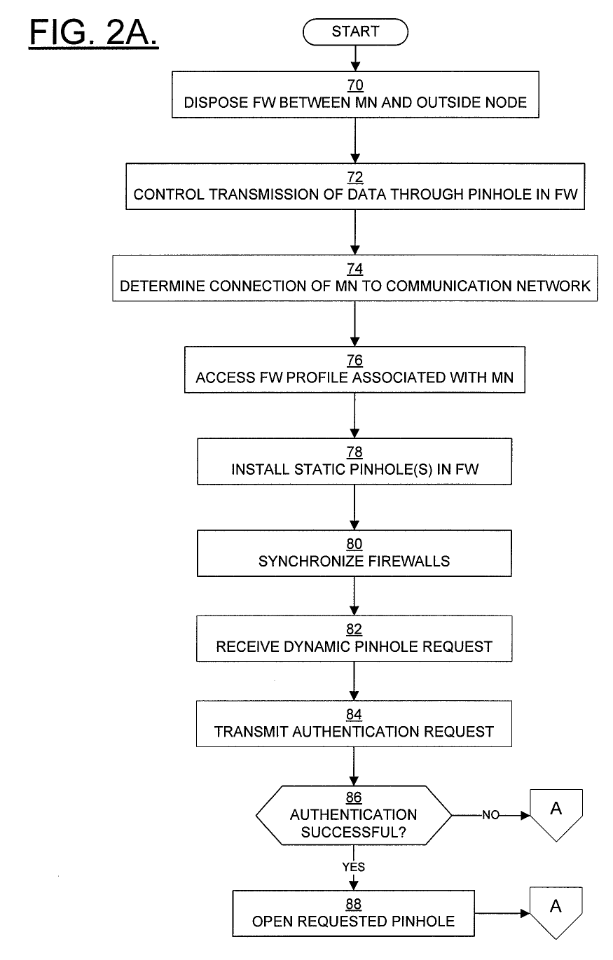

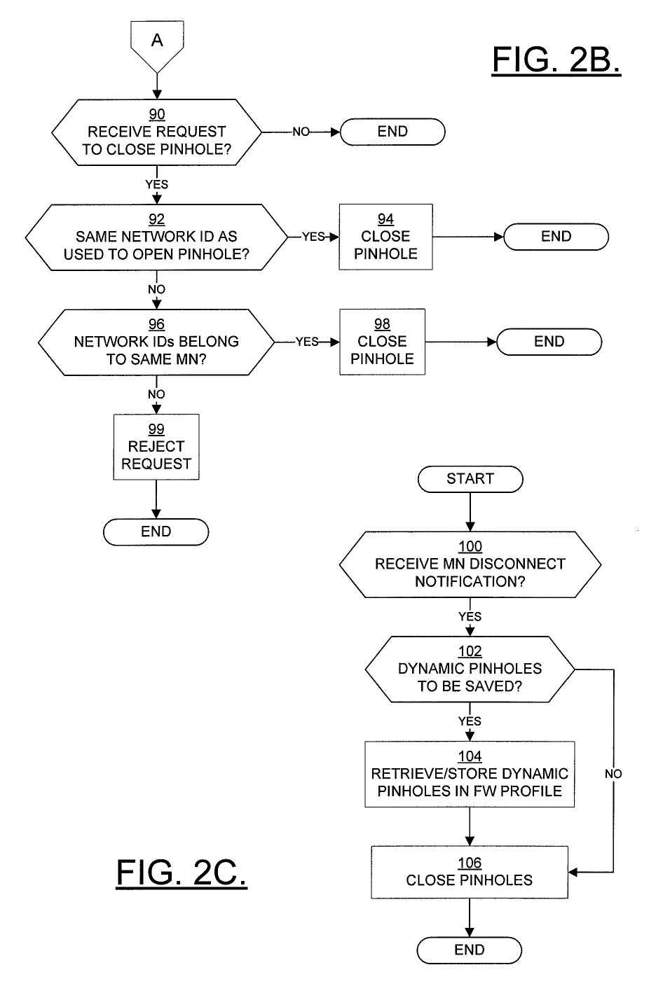

Referring now to FIGS. 2A, 2B, and 2C, a flowchart of the operation of providing firewall protection for a wireless communication network is illustrated, in accordance with one embodiment of the invention. FIGS. 2A and 2B illustrate the operation of providing firewall protection when a mobile node (MN) is accessing an outside node from within the MN's home access network, according to one embodiment. The operation of providing firewall protection when a MN is accessing an outside node from within a foreign access network will be described in detail below. One or more firewalls (FWs) may be disposed along a communication path between a MN, such as mobile node 10 of FIG. 1, and an outside node, such as IP network 28 of FIG. 1. See block 70 of FIG. 2A. The outside node may also be termed a connection node (CN). The transmission of data between the MN and the CN may be controlled through one or more pinholes in the firewall(s). See block 72. The MN may connect to a communication network, such as a CDMA2000 network, when the MN is powered up or when the MN comes within communication range of the network. The connection of the MN to the communication network may be determined by a Presence Agent (such as the PDSN 24a of FIG. 1). See block 74. A BSC (16a of FIG. 1), a PDSN, or any other suitable entity which has direct information about the attachment or detachment of a MN to/from the network may function as the Presence Agent. The Presence Agent will typically identify a MN by a Network Access Identifier (NAI), an International Mobile Subscriber Identity (IMSI), an Internet Protocol (IP) address, or any other suitable unique identifier. The Presence Agent will typically send a signal to the Profile Agent (27a of FIG. 1) that a MN has connected to or disconnected from the network. The Presence Agent would typically only need to support one specific communication protocol to signal the presence of a MN.

When the MN connects to the network and the Presence Agent signals this to the Profile Agent, the Profile Agent typically accesses a firewall profile that may be stored in memory at the Profile Agent. See block 76. The FW profile will typically define a list of pinholes to be installed on the FWs after the MN attaches to the network. The list may define one or more pinholes, or the list may at times be empty and define no pinholes. Such predefined pinholes may be termed static pinholes. Such a list may be defined when the user establishes service (i.e., subscribes) with a communication service provider. The FW profile may also define a list of dynamic pinholes installed in the FWs at the time the MN disconnects from the network, as well as a list of all of the IP addresses a MN is allowed to use within a certain IP address realm, as discussed in detail below. A MN may have a hypertext transfer protocol (HTTP) interface to enable the MN to make configuration changes to the MN's own FW profile in the Profile Agent. If a change to an active profile is made by the MN, the Profile Agent typically needs to react immediately and effectuate the corresponding change(s) to the pinhole(s). If the MN does not have an HTTP interface, the user of the MN may need to contact the wireless service provider to request changes to the list of static pinholes in the FW profile.

After accessing the FW profile of the MN, the Profile Agent typically installs the predefined static pinholes in one or more of the FWs. See block 78. The Profile Agent may use NSIS (Next Steps in Signaling) Signaling Layer Protocol (NSLP) in proxy mode to install the pinholes, or any other suitable protocol. The Profile Agent may install the pinholes in one FW, and then the FWs may synchronize to install the pinholes in all of the FWs. See block 80. The synchronization will typically be performed repeatedly to ensure the same static pinholes are open in each FW. Alternatively, the Profile Agent may install the pinholes in all of the FWs. Typically, the FW synchronization protocol is only needed when the Profile Agent installs predefined (static) pinholes. The pinholes opened in the FW upon the MN request (discussed below) typically do not need to be opened in other FWs than the one which processes the corresponding NSLP message (i.e., the FW in which the MN requests a pinhole). The Profile Agent would typically install the static pinholes in one of the FWs using the NSLP protocol. As the network typically does not know the purpose of a pinhole and therefore does not know to which FW to install a pinhole, the Profile Agent would typically install the pinhole in any one of the FWs. This is one reason why there may be a need for the FW synchronization protocol.

In addition to the static pinholes, the MN may dynamically request (i.e., during the communication with the network) that a pinhole be opened. Such a pinhole may be termed a dynamic pinhole. When the MN wants to exchange data with a CN (either initiated by the MN or by the CN outside the network), the MN typically uses NSLP to signal to the FW the required pinhole for the session. See block 82. Because NSLP is typically used to open the dynamic pinhole, the MN would generally need to have support for NSLP. As such, a MN that does not have support for NSLP (termed a legacy MN) would typically not be able to open a dynamic pinhole. This signal is typically an indirect communication, as NSLP would be used end-to-end. The pinhole may be opened in one of the FWs, without the need to open it in other FWs. The FW may want to authenticate the MN by transmitting an authentication, authorization and accounting (AAA) request to the Profile Agent. See block 84. The Profile Agent will then typically proxy the AAA request to the home AAA (H-AAA) server. The AAA authentication request is generally proxied through the Profile Agent (rather than directly to the H-AAA) in order to facilitate the authentication while the MN is roaming, as discussed below. If the authentication is successful, see block 86, the requested pinhole will typically be opened in the firewall. See block 88. After the initial authentication, it may be desirable for the MN to set up a security association with the FW to avoid the need for subsequent authentications.

Pinholes may have predefined expiration times, and such a pinhole is automatically closed when the expiration time elapses. If there is no predefined expiration time, the static and dynamic pinholes will typically remain open until either the MN sends a request to close a pinhole (see blocks 90-96) or until the MN disconnects from the network (see blocks 100-106 of FIG. 2C).

If the MN wants to modify an already installed pinhole, the MN may do so using the same network identifier (e.g., IP address) that was used to open the pinhole or the MN may use a different network identifier than was used to open the pinhole. As such, when the FW receives a request from the MN to close a pinhole, see block 90, the FW will determine if the network identifier is the same. See block 92. If the network identifier is the same, the FW will typically close the pinhole as requested. See block 94. If the network identifier is different, the FW will ask for authorization from the Profile Agent. As mentioned above, the FW profile may also contain all the network identifiers (e.g., IP addresses) that a MN is allowed to use within a certain IP address realm. This information may especially be needed in a multi-homing situation, in which a MN possesses several IP addresses and may want to use any of them to manage the MN's own list of pinholes. For example, a MN may open a pinhole using a first IP address, and modify (e.g., close) the pinhole using a second IP address. This action may be allowed if the FW is able to verify that the second IP address belongs to the same MN as the first IP address. If the FW profile contains all the IP addresses that a MN is allowed to use within one address realm, the FW could ask for authorization from the Profile Agent. If the Profile Agent determines that the IP address used to modify the pinhole belongs to the same MN as the IP address used to open the pinhole (see block 96), then the profile agent will authorize the pinhole modification request and the firewall will close the pinhole. Alternately, or additionally, if the Profile Agent determines that the network identifier (i.e., first network identifier) which the MN used to open the pinhole is different than a network identifier (i.e., second network identifier) that the MN is seeking to use to close the pinhole, the Profile Agent may still close the pinhole, if it determines that the first and second network identifiers correspond to a network entity such as, for example, a carrier owned policy control system, or an intrusion prevention system, or any kind of management system owned by the carrier, which is authorized to act on behalf of the MN, as known to those skilled in the art. See block 98. Otherwise the request might not be authorized and will be rejected. See block 99. The pinholes will typically remain open until a valid request is received to close a pinhole or until the MN disconnects from the network.

Referring now to FIG. 2C, the operation of closing pinholes upon the disconnect of the MN from the network is illustrated, in accordance with one embodiment of the invention. When the MN disconnects from the network, the Presence Agent signals to the Profile Agent such that the Profile Agent receives notification of the disconnect. See block 100. Optionally, the user of the MN may subscribe to a service to enable the open dynamic pinholes to be stored in the FW profile such that the pinholes may be reopened when the MN reconnects to the network. Such subscription information would also typically be contained in the FW profile. As such, the Profile Agent would determine if the dynamic pinholes are to be saved. See block 102. If the FW profile indicates that the dynamic pinholes are to be saved, then before closing the open pinholes, the Profile Agent would typically determine what pinholes are open and store that information in the FW profile. See block 104. As the FW profile already stores the static pinholes, this would typically only involve storing information about the dynamically established pinholes. Storing such information about which dynamic pinholes were open when the MN disconnected from the network allows the dynamic pinholes to be reopened by the Profile Agent when the MN reconnects to the network. This may be desirable for situations in which the MN disconnects from the network for a short period of time due to an interruption of the signal (e.g., when the user of the MN drives through a tunnel). The wireless service provider may predefine a time limit for the automatic reopening of the dynamic pinholes, such that the pinholes would not be reopened if the time between the disconnect and the reconnect exceeds the predefined time limit. The Profile Agent typically then closes all the pinholes (both static and dynamic) related to the MN using, e.g., the NSLP protocol. See block 106. The FWs would then typically need to synchronize.

The Profile Agent would typically need to support AAA protocols in order to respond or proxy the authentication and authorization requests the Profile Agent receives from the FW. The Profile Agent would also typically need to support the NSLP protocol in order to install and delete the pinholes of the MN and to fetch the list of pinholes of one specific MN. In addition, the Profile Agent would typically need to support the protocol to be used to signal the presence of a MN from the Presence Agent. The FWs would typically need to support the NSLP protocol in order to open pinholes as requested by a MN.

As mentioned above, FIGS. 2A and 2B illustrate the operation of providing firewall protection when a mobile node (MN) is accessing an outside node from within the MN's home access network, according to one embodiment. The operation of providing firewall protection when a MN is accessing an outside node from within a foreign access network (i.e., when the MN is roaming) is typically similar to the non-roaming operation. In such a roaming situation, the MN (10 of FIG. 1) may be communicating with the foreign access network 12b (which may also be termed the visited network). The PDSN 24b of the foreign access network would typically function as the Presence Agent. The Presence Agent in the foreign access network would typically communicate the presence of the MN to a Profile Agent in the foreign access network (such as Profile Agent 27b of FIG. 1). The Profile Agent in the foreign access network will typically contact the Profile Agent of the MN's home network, such that the MN's FW profile may be downloaded to the Profile Agent of the foreign access network. The Profile Agent of the foreign access network will then typically be able to install the static pinholes from the MN's FW profile and authorize pinhole requests coming from the FWs. The profile agent will also typically be able to proxy authentication requests from the FWs to the H-AAA. The profile agent might not always be in the path of the AAA authentication request sent by the FW to the H-AAA server.

The home agent (HA) (not shown) may be inside the protected Home Access Network (i.e., protected by FWs), while the foreign agent (FA) (not shown) is inside the protected Foreign Access Network (i.e., protected by FWs). In the roaming situation, the Mobile Internet Protocol (MIP) signaling messages have to reach the HA. As such, specific pinholes typically need to be opened in the Home Network FWs to allow the MIP signaling to reach the HA. In this scenario, the In-tunnel filtering can be avoided. The FWs both in the Home Network and the Foreign Network typically need a policy to allow traffic from HA to FA and vice-versa.

In the case of Version 4 of the MIP standard (termed IPv4 or MIPv4), the PDSN is typically required to do ingress filtering. As such, the MNs may make use of reverse tunneling. In this case, the NSLP signaling is sent in the tunnel to the Home Agent, and will interact with the FWs in the Home Network. The FWs in the Visited Network will typically not inspect MIP encapsulated NSLP protocol messages.

The FA could play the role of a Presence Agent and signal to the Visited Profile Agent the fact that it has allocated a Care-of Address (CoA) to a MN that just connected to the network. The MN's CoA and Home Address (HoA) could then be associated in the Visited Profile Agent, which would open the possibility for the MN to be reachable both on its HoA (NSLP opens pinholes in the Home Network's FWs) and the CoA (the FWs in the Visited Network can ask for authorization from the Visited Profile Agent) to any CN. The Visited Network generally needs to have the knowledge that the Home Network is filtering user traffic. Otherwise the FWs in the Visited Network will typically need to do in-tunnel filtering.

In the case of Version 6 of the MIP standard (termed IPv6 or MIPv6), route optimization typically does not require the HA involvement in the data, nor in some of the MIP signaling messages (HoTi, CoTi). The Type2 Routing Header of a packet sent to the CoA of a MN typically carries the MN's HoA, which could be used by the FWs for better filtering. The FWs would typically read both the CoA and the HoA from an incoming packet and query the Visited Profile Agent for authorization. If the binding exists, then the authorization would typically be granted and the FW would modify the pinhole already set up (by NSLP) to include Type2 Routing Header into that pinhole's filtering rules.

According to one exemplary aspect of embodiments of the invention, the functions performed by one or more of the entities of the system, such as the mobile node 10 and/or the FWs, may be performed by various means, such as hardware and/or firmware, including those described above, alone and/or under control of a computer program product. The computer program product for performing one or more functions of exemplary embodiments of the invention includes a computer-readable storage medium, such as the non-volatile storage medium, and software including computer-readable program code portions, such as a series of computer instructions, embodied in the computer-readable storage medium.

In this regard, FIG. 2 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. For example, while the mobile node is described to store various data, information or the like, the data, information or the like could, instead, be stored by a network entity, such as a proxy server, that is accessible by the mobile node. Although specific terms are employed herein, they are used in a generic and descriptive sense only and not for purposes of limitation.

What is claimed is:

1. A system for providing firewall protection for a wireless communication network, the system comprising:
a mobile node;
a firewall disposed along a communications path between the mobile node and an outside node, wherein the firewall is capable of controlling transmission of data between the outside node and the mobile node through a pinhole; and
a network entity capable of determining a connection of the mobile node to the wireless communication network, the network entity further capable of accessing a firewall profile associated with the mobile node, the firewall profile comprising at least one predefined static pinhole, the network entity further capable of instructing the firewall to open a pinhole corresponding to the at least one predefined static pinhole.

2. The system of claim 1, wherein the firewall is further capable of receiving a dynamic pinhole request from the mobile node, wherein the firewall is further capable of transmitting an authentication request, wherein the firewall is further capable of receiving a successful authentication, and wherein the firewall is further capable of opening a pinhole corresponding to the dynamic pinhole request in response to the successful authentication of the mobile node.

3. The system of claim 1, further comprising a plurality of firewalls, wherein the plurality of firewalls are capable of performing a pinhole synchronization such that any pinhole opening in at least one firewall is opened in all of the firewalls.

4. The system of claim 1, wherein the firewall is further capable of closing at least one pinhole in response to a request from the mobile node.

5. The system of claim 4, wherein the firewall profile further comprises all network identifiers corresponding to the mobile node.

6. The system of claim 5, wherein, if the firewall receives a request from the mobile node to close the pinhole using a second network identifier different than a first network identifier that was used by the mobile node to request to open the pinhole, the firewall is further capable of sending a verification request to the network entity to determine if the first and second network identifiers both correspond to the mobile node.

7. The system of claim 6, wherein the network entity closes the pinhole when it is determined that the first and second network identifiers both correspond to the mobile node.

8. The system of claim 7, wherein the network entity keeps the pinhole open when it is determined that the first and second network identifiers do not correspond to the mobile node and wherein the network entity closes the pinhole when the mobile node disconnects from the wireless communication network.

9. The system of claim 6, wherein the network entity closes the pinhole when it is determined that the first and second network identifiers do not correspond to the mobile node and wherein it is determined that the first and second network identifiers correspond to another network entity that is authorized to act on behalf of the mobile node.

10. The system of claim 6, wherein the network entity closes the pinhole when it is determined that the first and second network identifiers both correspond to the mobile node and wherein when the first and second network identifiers do not correspond to the mobile node, the network entity closes the pinhole when it is determined that another network entity is authorized to perform one or more actions on behalf of the mobile node.

11. The system of claim 1, further comprising one or more additional mobile nodes, wherein when the network entity determines that the mobile node, or the one or more additional mobile nodes, is connected to the wireless communication network, the network entity opens one or more pinholes, corresponding to the mobile node or the one or more additional mobile nodes, in the firewall based on data contained in the firewall profile or a dynamic pinhole request received from the mobile node or the one or more additional mobile nodes.

12. The system of claim 11, wherein when the mobile node, or the one or more additional mobile nodes, is no longer connected to the wireless communication network, the network entity closes a corresponding one of the one or more pinholes in the firewall.

13. A method for providing firewall protection for a wireless communication network, the method comprising:
controlling transmission of data between an outside node and a mobile node through a pinhole in a firewall that is disposed along a communications path between the mobile node and the outside node;
determining a connection of the mobile node to the wireless communication network;
accessing a firewall profile associated with the mobile node, the firewall profile comprising at least one predefined static pinhole; and
instructing the firewall to open a pinhole corresponding to the at least one predefined static pinhole.

14. The method of claim 13, further comprising:
receiving a dynamic pinhole request from the mobile node;
transmitting an authentication request;
receiving a successful authentication; and
opening a pinhole corresponding to the dynamic pinhole request in response to the successful authentication of the mobile node.

15. The method of claim 13, further comprising:
performing a pinhole synchronization among a plurality of firewalls such that any pinhole opening in at least one firewall is opened in all of the firewalls.

16. The method of claim 13, further comprising:
closing at least one pinhole in response to a request from the mobile node.

17. The method of claim 16, wherein the firewall profile further comprises all network identifiers corresponding to the mobile node.

18. The method of claim 17, further comprising:
receiving a request from the mobile node to close the pinhole using a second network identifier different than a first network identifier that was used by the mobile node to request to open the pinhole; and
sending a verification request to determine if the first and second network identifiers both correspond to the mobile node.

19. The method of claim 18 further comprising, closing the pinhole when it is determined that the first network identifier and the second network identifier both correspond to the mobile node.

20. The method of claim 18, further comprising:
keeping the pinhole open when it is determined that the first and second network identifiers do not correspond to the mobile node; and
closing the pinhole when the mobile node disconnects from the wireless communication network.

21. The method of claim 18, further comprising closing the pinhole when the network entity determines that the first and second network identifiers do not correspond to the mobile node and wherein when it is determined that the first and second network identifiers correspond to another network entity that is authorized to act on behalf of the mobile node.

22. The method of claim 18, further comprising:
closing the pinhole when it is determined that the first and second network identifiers both correspond to the mobile node; and
closing the pinhole when it is determined that the first and second network identifiers do not correspond to the mobile node, and when it is determined that another network entity is authorized to perform one or more actions on behalf of the mobile node.

23. The method of claim 13, further comprising:
disposing the firewall along the communications path between one or more additional mobile nodes and at least one outside node;
determining that the mobile node, or the one or more additional mobile nodes, is connected to the wireless communication network; and
opening the one or more pinholes, corresponding to the mobile node or the one or more additional mobile nodes, in the firewall based on data contained in the firewall profile or a dynamic pinhole request from the mobile node or the one or more additional mobile nodes.

24. The method of claim 23, further comprising:
determining that the mobile node, or the one or more additional mobile nodes, is no longer connected to the wireless communication network; and
closing a corresponding one of the one or more pinholes in the firewall.

25. A computer program product for providing firewall protection for a wireless communication network, the computer program product comprising at least one computer-readable storage medium having computer-readable program code portions stored therein, the computer-readable program code portions comprising:
a first executable portion for controlling transmission of data between an outside node and a mobile node through a pinhole in a firewall that is disposed along a communications path between the mobile node and the outside node;
a second executable portion for determining a connection of the mobile node to the wireless communication network;
a third executable portion for accessing a firewall profile associated with the mobile node, the firewall profile comprising at least one predefined static pinhole; and
a fourth executable portion for instructing the firewall to open a pinhole corresponding to the at least one predefined static pinhole.

26. The computer program product according to claim 25, further comprising:
a fifth executable portion for receiving a dynamic pinhole request from the mobile node;
a sixth executable portion for transmitting an authentication request;
a seventh executable portion for receiving a successful authentication; and
an eighth executable portion for opening a pinhole corresponding to the dynamic pinhole request in response to the successful authentication of the mobile node.

27. The computer program product according to claim 25, further comprising a fifth executable portion for performing a pinhole synchronization among a plurality of firewalls such that any pinhole opening in at least one firewall is opened in all of the firewalls.

28. The computer program product according to claim 25, further comprising a fifth executable portion for closing at least one pinhole in response to a request from the mobile node.

29. The computer program product according to claim 28, wherein the firewall profile further comprises all network identifiers corresponding to the mobile node.

30. The computer program product according to claim 29, further comprising:
a sixth executable portion for receiving a request from the mobile node to close the pinhole using a second network identifier different than a first network identifier that was used by the mobile node to request to open the pinhole; and
a seventh executable portion for sending a verification request to determine if the first and second network identifiers both correspond to the mobile node.

31. The computer program product according to claim 30, further comprising an eighth executable code for closing the pinhole when it is determined that the first and second network identifiers both correspond to the mobile node.

32. The computer program product according to claim 30, further comprising:
an eighth executable portion for keeping the pinhole open when it is determined that the first and second network identifiers do not correspond to the mobile node and;
a ninth executable portion for closing the pinhole when the mobile node disconnects from the wireless communication network.

33. The computer program product according to claim 30, further comprising an eighth executable portion for closing the pinhole when the network entity determines that the first and second network identifiers do not correspond to the mobile node and wherein when it is determined that the first and second network identifiers correspond to another network entity that is authorized to act on behalf of the mobile node.

34. The computer program product according to claim 30, further comprising:
an eighth executable portion for closing the pinhole when it is determined that the first and second network identifiers both correspond to the mobile node; and
a ninth executable portion for closing the pinhole when it is determined that the first and second network identifiers do not correspond to the mobile node, and when it is determined that another network entity is authorized to perform one or more actions on behalf of the mobile node.

35. The computer program product according to claim 25, further comprising:
a fifth executable portion for disposing the firewall along the communications path between one or more additional mobile nodes and at least one outside node;
a sixth executable portion for determining that the mobile node, or the one or more additional mobile nodes, is connected to the wireless communication network; and
a seventh executable portion for opening the one or more pinholes, corresponding to the mobile node or the one or more additional mobile nodes, in the firewall based on data contained in the firewall profile or a dynamic pinhole request from the mobile node or the one or more additional mobile nodes.

36. The computer program product according to claim 35, further comprising:
an eighth executable portion for determining that the mobile node, or the one or more additional mobile nodes, is no longer connected to the wireless communication network; and
a ninth executable portion for closing a corresponding one of the one or more pinholes in the firewall.

37. A network element for providing firewall protection for a wireless communication network, the network element comprising a processing element configured to:
determine a connection of a mobile node to the wireless communication network;
access a firewall profile associated with the mobile node, the firewall profile comprising at least one predefined static pinhole; and
instruct the firewall to open a pinhole corresponding to the at least one predefined static pinhole.

38. The network element according to claim 37, wherein the processing element is further configured to:
receive a request from the mobile node to close at least one pinhole using a second network identifier different than a first network identifier that was used by the mobile node to request to open the at least one pinhole; and
receive a verification request from the firewall to determine if the first and second network identifiers both correspond to the mobile node.

39. The network element according to claim 38, wherein the processing element is further configured to close the at least one pinhole when it is determined that the first and second network identifiers both correspond to the mobile node.

40. The network element according to claim 39, wherein the processing element is further configured to:
keep the at least one pinhole open when it is determined that the first and second network identifiers do not correspond to the mobile node; and
close the at least one pinhole when the mobile node disconnects from the wireless communication network.
